(19) United States
(12) Patent Application Publication
(10) Pub. No.: US 2024/0357562 A1
(43) Pub. Date: Oct. 24, 2024

(54) METHOD FOR TRANSMITTING TIME-FREQUENCY RESOURCE CONFIGURATION INFORMATION, COMMUNICATION APPARATUS AND NON-TRANSITORY COMPUTER-READABLE STORAGE MEDIUM

(71) Applicant: BEIJING XIAOMI MOBILE SOFTWARE CO., LTD., Beijing (CN)

(72) Inventor: Rui ZHOU, Beijing (CN)

(73) Assignee: BEIJING XIAOMI MOBILE SOFTWARE CO., LTD., Beijing (CN)

(21) Appl. No.: 18/683,509

(22) PCT Filed: Aug. 20, 2021
(86) PCT No.: PCT/CN2021/113791

§ 371 Date: Feb. 14, 2024

(51) Int. Cl. H04W 72/044; H04L 5/00

(52) U.S. Cl. CPC H04W 72/044; H04L 5/0005

(57) ABSTRACT

A method for transmitting time-frequency resource configuration information, performed by a network device, and including: determining time-frequency resource configuration information for user equipment based on inter-frequency simultaneous transmission capability of the user equipment; wherein the inter-frequency simultaneous transmission capability is used for indicating capability of the user equipment to transmit service data of a first communication interface and service data of a second communication interface simultaneously on a same time domain unit corresponding to different frequency points within a same licensed frequency band; and sending the time-frequency resource configuration information to the user equipment.

### CROSS REFERENCE TO RELATED APPLICATIONS

The present application is a U.S. National Phase of International Application No. PCT/CN2021/113791, filed on Aug. 20, 2021, the contents of all of which are incorporated herein by reference in their entireties for all purposes.

### TECHNICAL FIELD

The present disclosure relates to the field of wireless communication technology, and in particular, to a method and apparatus for transmitting time-frequency resource configuration information, and a readable storage medium.

### BACKGROUND

With the development of wireless communication technology, the use requirement of the service provider for frequency bands are increasingly increased; and with the increase of this requirement and the gradual reduction of the frequency bands available for allocation, there is a need to effectively utilize the existing licensed frequency bands.

### SUMMARY

In a first aspect, according to embodiments of the present disclosure, there is provided a method for transmitting time-frequency resource configuration information. The method is performed by a network device, and the method includes:
determining time-frequency resource configuration information for user equipment based on an inter-frequency simultaneous transmission capability of the user equipment; where the inter-frequency simultaneous transmission capability is used for indicating a capability of the user equipment to transmit service data of a first communication interface and service data of a second communication interface simultaneously on a same time domain unit corresponding to different frequency points within a same licensed frequency band; and
sending the time-frequency resource configuration information to the user equipment.

In a second aspect, according to embodiments of the present disclosure, there is provided a method for transmitting time-frequency resource configuration information. The method is performed by a user equipment, and the method includes:
receiving time-frequency resource configuration information from a network device;
where the time-frequency resource configuration information is determined by the network device based on an inter-frequency simultaneous transmission capability of the user equipment; and the inter-frequency simultaneous transmission capability is used for indicating a capability of the user equipment to transmit service data of a first communication interface and service data of a second communication interface simultaneously on a same time domain unit corresponding to different frequency points within a same licensed frequency band.

In a third aspect, according to the present disclosure, there is provided a communication apparatus, including a processor and a memory, where the memory is configured to store a computer program; and the processor is configured to execute the computer program to implement the first aspect or any one possible design of the first aspect.

It should be understood that the above general description and the following detailed description are merely exemplary and explanatory, and cannot limit the present disclosure.

### BRIEF DESCRIPTION OF THE DRAWINGS

The accompanying drawings described here, which are used to provide a further understanding of the embodiments of the present disclosure, constitute a part of the present disclosure. The illustrative embodiments of the embodiments of the present disclosure and the description of them are used to explain the embodiments of the present disclosure, and do not constitute an improper limitation on the embodiments of the present disclosure.

The accompanying drawings, which are incorporated in and constitute a part of the description, illustrate embodiments consistent with the disclosure and together with the description serve to explain the principles of the disclosure.

FIG. 1 is a schematic architectural diagram of a wireless communication system according to some embodiments of the present disclosure;

FIG. 2 is a flowchart of a method for transmitting time-frequency resource configuration information illustrated according to some embodiments of the present disclosure;

FIG. 3 is a schematic diagram of the correspondence between the reporting result and the user equipment capability illustrated according to some embodiments of the present disclosure;

FIG. 4 is a schematic diagram of time-frequency resource configuration illustrated according to some embodiments of the present disclosure;

FIG. 5 is a structural diagram of an apparatus for transmitting time-frequency resource configuration information illustrated according to some embodiments of the present disclosure;

FIG. 6 is a structural diagram of another apparatus for transmitting time-frequency resource configuration information illustrated according to some embodiments of the present disclosure;

FIG. 7 is a structural diagram of an apparatus for transmitting time-frequency resource configuration information illustrated according to some embodiments of the present disclosure;

FIG. 8 is a schematic structural diagram of another apparatus for transmitting time-frequency resource configuration information illustrated according to some embodiments of the present disclosure.

### DETAILED DESCRIPTION

The embodiments of the present disclosure are further described with reference to the accompanying drawings and specific implementations.

Example embodiments will be described in detail here, examples of which are illustrated in the accompanying drawings. The following description refers to the accompanying drawings in which the same numerals in different drawings represent the same or similar elements, unless otherwise represented. The implementations described in the following example embodiments do not represent all implementations consistent with the embodiments of the present disclosure. By contrast, they are merely examples of apparatuses and methods consistent with some aspects of the present disclosure as detailed in the appended claims.

On the same licensed frequency band of the service provider, the requirement for simultaneous transmission of different services may be involved. In this scene, how to allocate a time-frequency resource under the condition of effectively utilizing the existing licensed frequency band is a problem that needs to be solved.

As shown in FIG. 1, the method for transmitting time-frequency resource configuration information provided according to embodiments of the present disclosure may be applied to a wireless communication system 100. The wireless communication system may include user equipment 101 and a network device 102, where the user equipment 101 is configured to support carrier aggregation, and the user equipment 101 may be connected to a plurality of carrier units of the network device 102, which includes a main carrier unit and one or more secondary carrier units.

It should be understood that the above wireless communication system 100 may be suitable for both low-frequency scenes and high-frequency scenes. An application scene of the wireless communication system 100 includes, but is not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, or a future evolved public land mobile network (PLMN) system, etc.

The user equipment 101 (UE) shown above may be a terminal, an access terminal, a terminal unit, a terminal station, a mobile station (MS), a remote station, a remote terminal, a mobile terminal, a wireless communication device, a terminal agent, or a terminal device, etc. The user equipment 101 may have a wireless transceiving function, and may be capable of perform communication (such as wireless communication) with one or more network devices 102 of one or more communication systems and receiving a network service provided by the network device 102. The network device 102 here includes, but is not limited to, the illustrated network device 102.

Among them, the user equipment 101 may be a cellular phone, a cordless telephone, a session initiation protocol (SIP) phone, a wireless local loop (WLL) station, a personal digital assistant (PDA) device, a handheld device having a wireless communication function, a computing device or another processing device connected to a wireless modem, a vehicle-mounted device, a wearable device, a terminal device in a future 5G network, or a terminal device in a future evolved PLMN network, etc.

The network device 102 may be an access network device (or referred to as an access network station). Among them, the access network device refers to a device that provides a network access function, such as a radio access network (RAN) base station, etc. The network device 102 may specifically include a base station (BS), or may include a base station and a radio resource management device for controlling the base station, etc. The network device 102 may further include a relay station (a relay device), an access point, a base station in a future 5G network, a base station in a future evolved PLMN network or an NR base station, etc. The network device 102 may be a wearable device or a vehicle-mounted device. The network device 102 may also be a communication chip having a communication module.

For example, the network device 102 includes, but is not limited to: a gnodeB (gNB) in 5G system, an evolved node B (eNB) in a LTE system, a radio network controller (RNC), a node B (NB) in a WCDMA system, a radio controller in a CRAN system, a base station controller (BSC), a base transceiver station (BTS) in a GSM system or a CDMA system, a home base station (such as a home evolved nodeB, or a home node B (HNB)), a baseband Unit (BBU), a transmitting and receiving Point (TRP), a transmitting point (TP), or mobile switching center, etc.

The vehicle to everything (V2X) is a new generation of information communication technology for connecting the vehicle to all things. In a scene that different services are simultaneously transmitted on a same licensed frequency band, it relates to simultaneously transmitting a new radio (NR) service and a V2X service on a same licensed frequency band.

Sidelink (SL) is a new type of link introduced to support direct communication between V2X devices. For the user equipment 101, it relates to simultaneously transmitting an NR service and a sidelink (SL) service on a same licensed frequency band.

The NR service corresponds to a cellular communication interface (Uu interface), and the SL service corresponds to a sidelink communication interface (PC5 interface). Therefore, in the process of simultaneously transmitting different services on the same licensed frequency band, it relates to different transmission situations of two communication interfaces of a Uu interface (a cellular communication interface) and a PC5 interface (a sidelink communication interface) simultaneously on the same NR frequency band.

In an application scene in which data is simultaneously transmitted at the Uu interface and the PC5 interface on the same NR frequency band, the user equipment 101 has different inter-frequency simultaneous transmission capabilities. To this end, the network device 102 needs to know the specific capability of the user equipment, so as to configure reasonable time-frequency resources for the user equipment with different capabilities; otherwise, the network device 102 may easily cause unreasonable scheduling to the user equipment with different capabilities, thus wasting the network resources, or resulting in abnormal data transmission.

In the present disclosure, the network device 102 may clearly obtain different inter-frequency simultaneous transmission capabilities of the user equipment 101, and perform time-frequency resource configuration in combination with the inter-frequency simultaneous transmission capability of the user equipment 101, so as to perform reasonable scheduling.

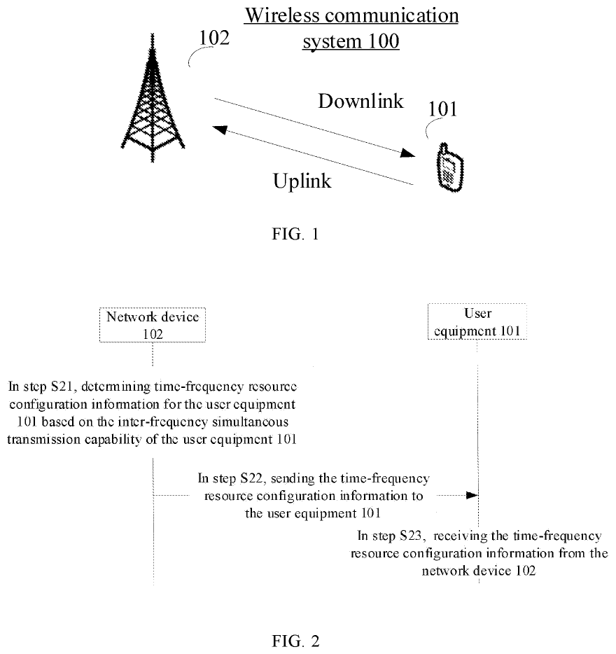

According to embodiments of the present disclosure, there is provided a method for transmitting time-frequency resource configuration information. Referring to FIG. 2, FIG. 2 is a flowchart of a method for transmitting time-frequency resource configuration information illustrated according to some embodiments of the present disclosure. As shown in FIG. 2, the method includes the following.

In step S21, the network device 102 determines time-frequency resource configuration information for the user equipment 101 based on the inter-frequency simultaneous transmission capability of the user equipment 101; where the inter-frequency simultaneous transmission capability is used for indicating the capability of the user equipment 101 to transmit the service data of the first communication interface and the service data of the second communication interface simultaneously on the same time domain unit corresponding to different frequency points within the same licensed frequency band.

In step S22, the network device 102 sends the time-frequency resource configuration information to the user equipment 101.

In step S23, the user equipment 101 receives the time-frequency resource configuration information from the network device 102. Among them, the time-frequency resource configuration information is determined by the network device 102 based on the inter-frequency simultaneous transmission capability of the user equipment 101; the inter-frequency simultaneous transmission capability is used for indicating the capability of the user equipment 101 to transmit the service data of the first communication interface and the service data of the second communication interface simultaneously on the same time domain unit corresponding to different frequency points within the same licensed frequency band.

In some embodiments, in step S21, the network device 102 may actively obtain the inter-frequency simultaneous transmission capability of the user equipment 101; or, the network device 102 may obtain the inter-frequency simultaneous transmission capability of the user equipment 101 according to the information reported by the user equipment 101.

According to embodiments of the present disclosure, there is provided a method for transmitting time-frequency resource configuration information. This method is performed by the network device 102, and the method includes the following.

In step S1, the time-frequency resource configuration information for the user equipment 101 is determined based on the inter-frequency simultaneous transmission capability of the user equipment 101, where the inter-frequency simultaneous transmission capability is used for indicating the capability of the user equipment 101 to transmit the service data of the first communication interface and the service data of the second communication interface simultaneously on the same time domain unit corresponding to different frequency points within the same licensed frequency band.

In step S2, the time-frequency resource configuration information is sent to the user equipment 101.

In some embodiments, the time domain unit may be a slot, or may be a half slot, or may be a quarter slot, or may be a unit with a smaller duration.

In some embodiments, the user equipment 101 may report the inter-frequency simultaneous transmission capability of the user equipment 101 to the network device 102. In the information reported by the user equipment 101, the inter-frequency simultaneous transmission capability may occupy two bits or more than two bits.

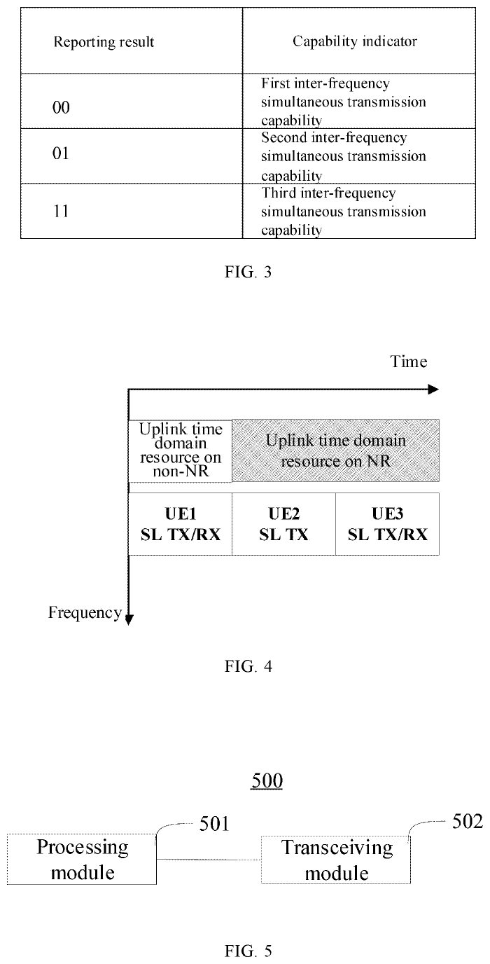

In some embodiments, as shown in FIG. 3, in the information reported by the user equipment 101, the inter-frequency simultaneous transmission capability may occupy two bits. For example, “00” is used to represent a first inter-frequency simultaneous transmission capability, “01” is used to represent a second inter-frequency simultaneous transmission capability, and “11” is used to represent a third inter-frequency simultaneous transmission capability. The specific content corresponding to the three inter-frequency simultaneous transmission capabilities may be determined according to a protocol.

Among them, the inter-frequency simultaneous transmission capability is a capability evaluation of the user equipment 101 to transmit service data through two interfaces in the same time domain unit corresponding to different frequency points within the same licensed frequency band.

For the user equipment 101 having different inter-frequency simultaneous transmission capabilities, the network device 102 may determine the time-frequency resource configuration information corresponding to different user equipment 101 in step S21. Thus, in step S22, the network device 102 may send the time-frequency resource configuration information corresponding to the user equipment 101 to the corresponding user equipment 101.

In the embodiments of the present disclosure, the network device 102 may configure different time-frequency resource configuration information for the user equipment with different inter-frequency simultaneous transmission capabilities according to the inter-frequency simultaneous transmission capability of the user equipment 101, so as to configure reasonable time-frequency resource configuration information for various user equipment with different inter-frequency simultaneous transmission capabilities, and reasonably schedule the user equipment with different capabilities, thus avoiding the problem of network resource waste caused by weak scheduling performed on the user equipment with relatively strong inter-frequency simultaneous transmission capability, and avoiding the problem of abnormal data transmission caused by strong scheduling performed on the user equipment with relatively weak inter-frequency simultaneous transmission capability.

According to embodiments of the present disclosure, there is provided a method for transmitting time-frequency resource configuration information. The method is performed by a network device 102, and in this method:
a time domain resource corresponding to the first communication interface includes an uplink time domain unit and a downlink time domain unit; and a time domain resource corresponding to the second communication interface only includes an uplink time domain unit;
the same time domain unit is a same uplink time domain unit in the time domain resource corresponding to the first communication interface.

In some embodiments, the second communication interface can only use the uplink time domain resource of the first communication interface in the data transmission process, but cannot use the downlink time domain resource of the first communication interface. That is, the data of the second communication interface can only be transmitted on the uplink time domain resource of the first communication interface, but cannot be transmitted on the downlink time domain resource of the first communication interface. Therefore, in an inter-frequency simultaneous application scene, the user equipment 101 can only send the uplink data through the first communication interface, but can send the uplink data and receive the downlink data through the first communication interface.

In some embodiments, the first communication interface is a cellular communication interface (Uu interface), and the second communication interface is a sidelink communication interface (PC5 interface). Among them, the same licensed frequency band is a licensed frequency band corresponding to a cellular communication interface (Uu interface), and may also be referred to as an NR frequency band.

When the first communication interface is a cellular communication interface (Uu interface) and the second communication interface is a sidelink communication interface (PC5 interface), and when the user equipment 101 relates to transmitting the service data of the Uu interface and the service data of the PC5 interface simultaneously on the same time domain unit corresponding to different frequency points within the same NR frequency band, the network device 102 may configure reasonable time-frequency resource configuration information for a plurality of user equipment 101 having different inter-frequency simultaneous transmission capabilities in combination of the inter-frequency simultaneous transmission capabilities of the user equipment 101, and reasonably schedule the user equipment 101 with different capabilities.

According to embodiments of the present disclosure, there is provided a method for transmitting time-frequency resource configuration information. The method is performed by a network device 102. In this method, step S21 includes the following.

The inter-frequency simultaneous transmission capability of the user equipment 101 includes the following capabilities of:
sending the service data of the first communication interface and the service data of the second communication interface simultaneously on the same time domain unit corresponding to different frequency points within the same licensed frequency band; and
sending the service data of the first communication interface and receiving the service data of the second communication interface simultaneously on the same time domain unit corresponding to different frequency points within the same licensed frequency band.

The time-frequency resource configuration information for the user equipment 101 includes one of the following:
an uplink time domain resource corresponding to the first communication interface including an uplink time domain resource of the second communication interface and a downlink time domain resource of the second communication interface;
an uplink time domain resource corresponding to the first communication interface including an uplink time domain resource of the second communication interface; and
an uplink time domain resource corresponding to the first communication interface including a downlink time domain resource of the second communication interface.

In some embodiments, the specific bit value of the inter-frequency simultaneous transmission capability reported by the user equipment 101 and received by the network device 102 is “11”. The inter-frequency simultaneous transmission capability of the user equipment 101 is determined according to the correspondence between the bit value and the specific capability content.

In the embodiments of the present disclosure, the network device 102 configures a relatively flexible time-frequency resource configuration for the user equipment 101 with a relatively strong inter-frequency simultaneous transmission capability, so as to make full use of the inter-frequency simultaneous transmission capability of the user equipment.

According to embodiments of the present disclosure, there is provided a method for transmitting time-frequency resource configuration information. The method is performed by a network device 102, and in this method, step S21 includes the following.

The inter-frequency simultaneous transmission capability of the user equipment 101 includes the following capability of:
sending the service data of the first communication interface and sending the service data of the second communication interface simultaneously on the same time domain unit corresponding to different frequency points within the same licensed frequency band.

The time-frequency resource configuration information for the user equipment 101 includes:
an uplink time domain resource corresponding to the first communication interface including an uplink time domain resource of the second communication interface, and not including a downlink time domain resource of the second communication interface.

In some embodiments, the specific bit value of the inter-frequency simultaneous transmission capability reported by the user equipment 101 and received by the network device 102 is “01”. The inter-frequency simultaneous transmission capability of the user equipment 101 is determined according to the correspondence between the bit value and the specific capability content.

In the embodiments of the present disclosure, the network device only configures the uplink time domain resource of the second communication interface in the uplink time domain resource corresponding to the first communication interface for the user equipment with moderate inter-frequency simultaneous transmission capability, so as to make full use of the inter-frequency simultaneous sending capability of the user equipment.

According to embodiments of the present disclosure, there is provided a method for transmitting time-frequency resource configuration information. The method is performed by a network device 102, and in this method, step S21 includes the following.

The inter-frequency simultaneous transmission capability of the user equipment 101 does not include any one of the following capabilities of:
sending the service data of the first communication interface and sending the service data of the second communication interface simultaneously on the same time domain unit corresponding to different frequency points within the same licensed frequency band; and
sending the service data of the first communication interface and receiving the service data of the second communication interface simultaneously on the same time domain unit corresponding to different frequency points within the same licensed frequency band;

The time-frequency resource configuration information for the user equipment 101 includes:
an uplink time domain resource corresponding to the first communication interface not including an uplink time domain resource of the second communication interface, and not including a downlink time domain resource of the second communication interface.

In some embodiments, the specific bit value of the inter-frequency simultaneous transmission capability reported by the user equipment 101 and received by the network device 102 is “00”. The inter-frequency simultaneous transmission capability of the user equipment 101 is determined according to the correspondence between the bit value and the specific capability content.

In the embodiment of the present disclosure, the network device configures the time-frequency resource configuration information for the user equipment with the worst inter-frequency simultaneous transmission capability, so as to prevent a data transmission conflict between the first communication interface and the second communication interface.

According to embodiments of the present disclosure, there is provided a method for transmitting time-frequency resource configuration information. The method is performed by a network device 102, and the method further includes:
sending a reporting command to the user equipment 101, where the reporting command is used for instructing the user equipment 101 to report the inter-frequency simultaneous transmission capability of the user equipment 101.

In some embodiments, after receiving the reporting command sent by the network device 102, the user equipment 101 reports the inter-frequency simultaneous transmission capability.

According to embodiments of the present disclosure, there is provided a method for transmitting time-frequency resource configuration information. The method is performed by a network device 102, and the method further includes:
receiving a reporting result of the user equipment 101, where the reporting result is used for indicating the inter-frequency simultaneous transmission capability of the user equipment 101.

In some embodiments, after receiving the reporting command sent by the network device 102, the user equipment 101 sends the reporting result.

After receiving the reporting result, the network device 102 may determine the inter-frequency simultaneous transmission capability of the user equipment 101 according to the reporting result, and perform step S21 and step S22.

A specific example is described below with reference to FIG. 3 and FIG. 4.

The content of the field reported by the UE1 for indicating the inter-frequency simultaneous transmission capability is “00”, which corresponds to the first inter-frequency simultaneous transmission capability, and the first inter-frequency simultaneous transmission capability does not include any one of the following capabilities of:
sending the service data of the Uu interface and sending the service data of the PC5 interface simultaneously on the same time domain unit corresponding to different frequency points within the same NR licensed frequency band; and
sending the service data of the Uu interface and receiving the service data of the PC5 interface simultaneously on the same time domain unit corresponding to different frequency points within the same NR licensed frequency band.

The content of the field reported by the UE2 for indicating the inter-frequency simultaneous transmission capability is “01”, which corresponds to a second inter-frequency simultaneous transmission capability, and the second inter-frequency simultaneous transmission capability includes the following capability of:
sending the service data of the Uu interface and sending the service data of the PC5 interface simultaneously on the same time domain unit corresponding to different frequency points within the same NR licensed frequency band.

The content of the field reported by the UE3 for indicating the inter-frequency simultaneous transmission capability is “11”, which corresponds to a third inter-frequency simultaneous transmission capability, and the third inter-frequency simultaneous transmission capability includes the following capabilities of:
sending the service data of the Uu interface and sending the service data of the PC5 interface simultaneously on the same time domain unit corresponding to different frequency points within the same NR licensed frequency band; and
sending the service data of the Uu interface and receiving the service data of the PC5 interface simultaneously on the same time domain unit corresponding to different frequency points within the same NR licensed frequency band.

Among them, the inter-frequency simultaneous transmission capabilities of the UE1, the UE2, and the UE3 are from weak to strong successively.

The network device 102 configures the time-frequency resource configuration information that matches the inter-frequency simultaneous transmission capability of each UE according to the inter-frequency simultaneous transmission capabilities of the UE1, the UE2, and the UE3. In some embodiments, it is as shown in FIG. 4.

For the UE1, the uplink time domain resource corresponding to the Uu interface is not configured with the uplink time domain resource of the PC5 interface, and not configured with the downlink time domain resource of the PC5 interface, so that when the SL service is performed, the NR service is not performed simultaneously.

For the UE2, the uplink time domain resource corresponding to the Uu interface is configured with the uplink time domain resource of the PC5 interface, and not configured with the downlink time domain resource of the PC5 interface, so that the UE2 may inter-frequency simultaneously send the uplink data of the Uu interface and the uplink data of the PC5 interface.

For UE3, the uplink time domain resource corresponding to the Uu interface is configured with the uplink time domain resource of the PC5 interface, and/or is configured with the downlink time domain resource of the PC5 interface. That is, the uplink time domain resource corresponding to the Uu interface is arbitrarily configured with the time domain resource of the PC5 interface. Thus, the UE3 may inter-frequency simultaneously send the uplink data of the Uu interface and send the uplink data of the PC5 interface, or inter-frequency simultaneously send the uplink data of the Uu interface and receive the downlink data of the receiving PC5 interface.

According to embodiments of the present disclosure, there is provided a method for transmitting time-frequency resource configuration information. The method is performed by user equipment 101. The method includes the following.

In step S1-1, time-frequency resource configuration information is received from a network device 102.

Among them, the time-frequency resource configuration information is determined by the network device 102 based on the inter-frequency simultaneous transmission capability of the user equipment 101, and the inter-frequency simultaneous transmission capability is used for indicating the capability of the user equipment 101 to transmit the service data of the first communication interface and the service data of the second communication interface simultaneously on the same time domain unit corresponding to different frequency points within the same licensed frequency band.

In some embodiments, the time domain unit may be a slot, or may be a half slot, or may be a quarter slot, or may be a unit with a smaller duration.

In some embodiments, the user equipment 101 may report the inter-frequency simultaneous transmission capability of the user equipment 101 to the network device 102. In the information reported by the user equipment 101, the inter-frequency simultaneous transmission capability may occupy two bits or more than two bits.

In some embodiments, as shown in FIG. 3, in the information reported by the user equipment 101, the inter-frequency simultaneous transmission capability may occupy two bits. For example, “00” is used to represent a first inter-frequency simultaneous transmission capability, and “01” is used to represent a second inter-frequency simultaneous transmission capability, and “11” is used to represent a third inter-frequency simultaneous transmission capability.

According to embodiments of the present disclosure, there is provided a method for transmitting time-frequency resource configuration information. The method is performed by user equipment 101. The method includes steps S1-1.

Among them, a time domain resource corresponding to the first communication interface includes an uplink time domain unit and a downlink time domain unit;
a time domain resource corresponding to the second communication interface only includes an uplink time domain unit; and
the same time domain unit is a same uplink time domain unit in a time domain resource corresponding to the first communication interface.

In some embodiments, the first communication interface is a cellular communication interface, and the second communication interface is a sidelink communication interface.

According to embodiments of the present disclosure, there is provided a method for transmitting time-frequency resource configuration information. The method is performed by user equipment 101. The method includes steps S1-1, and further includes:
receiving a reporting command from the network device 102, where the reporting command is used for instructing the user equipment 101 to report the inter-frequency simultaneous transmission capability of the user equipment 101.

According to embodiments of the present disclosure, there is provided a method for transmitting time-frequency resource configuration information. The method is performed by user equipment 101. The method includes steps S1-1, and further includes:
sending a reporting result of the user equipment 101 to the network device 102, where the reporting result is used for indicating the inter-frequency simultaneous transmission capability of the user equipment 101.

In some embodiments, a specific inter-frequency simultaneous transmission capability may be may represented through two bits in the reporting result. For example, “00” represents a first inter-frequency simultaneous transmission capability, “01” represents a second inter-frequency simultaneous transmission capability, and “11” represents a third inter-frequency simultaneous transmission capability.

According to embodiments of the present disclosure, there is provided a method for transmitting time-frequency resource configuration information. The method is performed by user equipment 101. The method includes steps S1-1, and determining time-frequency resource configuration information for the user equipment 101 based on the inter-frequency simultaneous transmission capability of the user equipment 101 includes the following.

The inter-frequency simultaneous transmission capability of the user equipment 101 includes the following capabilities of:
sending the service data of the first communication interface and sending the service data of the second communication interface simultaneously on the same time domain unit corresponding to different frequency points within the same licensed frequency band; and
sending the service data of the first communication interface and receiving the service data of the second communication interface simultaneously on the same time domain unit corresponding to different frequency points within the same licensed frequency band.

The time-frequency resource configuration information for the user equipment 101 includes one of the following:
an uplink time domain resource corresponding to the first communication interface including an uplink time domain resource of the second communication interface and a downlink time domain resource of the second communication interface;
an uplink time domain resource corresponding to the first communication interface including an uplink time domain resource of the second communication interface; and
an uplink time domain resource corresponding to the first communication interface including a downlink time domain resource of the second communication interface.

According to embodiments of the present disclosure, there is provided a method for transmitting time-frequency resource configuration information. The method is performed by user equipment 101. The method includes steps S1-1, and the inter-frequency simultaneous transmission capability of the user equipment 101 includes the following capability of:
sending the service data of the first communication interface and sending the service data of the second communication interface simultaneously on the same time domain unit corresponding to different frequency points within the same licensed frequency band.

The time-frequency resource configuration information for the user equipment 101 includes:
an uplink time domain resource corresponding to the first communication interface including an uplink time domain resource of the second communication interface, and not including a downlink time domain resource of the second communication interface. According to embodiments of the present disclosure, there is provided a method for transmitting time-frequency resource configuration information. The method is performed by user equipment 101. The method includes step S101, and the inter-frequency simultaneous transmission capability of the user equipment 101 does not include any one of the following capabilities of:
sending the service data of the first communication interface and sending the service data of the second communication interface simultaneously on the same time domain unit corresponding to different frequency points within the same licensed frequency band; and
sending the service data of the first communication interface and receiving the service data of the second communication interface simultaneously on the same time domain unit corresponding to different frequency points within the same licensed frequency band.

The time-frequency resource configuration information for the user equipment 101 includes:
an uplink time domain resource corresponding to the first communication interface not including an uplink time domain resource of the second communication interface, and not including a downlink time domain resource of the second communication interface.

Based on the same concept as that in the foregoing method embodiments, according to embodiments of the present disclosure, there is further provided a communication apparatus. The communication apparatus may have the functions of the network device 102 in the foregoing method embodiments, and may be used to perform the steps performed by the network device 102 provided by the foregoing method embodiments. The functions may be implemented by hardware, or may be implemented by software or by hardware that executes corresponding software. The hardware or software includes one or more modules corresponding to the foregoing functions.

In a possible implementation, the communication apparatus 500 shown in FIG. 5 may be used as the network device 102 involved in the foregoing method embodiments, and perform the steps performed by the network device 102 in the foregoing method embodiments. As shown in FIG. 5, the communication apparatus 500 may include a processing module 501 and a transceiving module 502. The processing module 501 and the transceiving module 502 are coupled to each other. The processing module 501 may be configured for the communication apparatus 500 to perform a processing operation, including but not limited to: generating information and a message sent by the transceiving module 501, and/or demodulating and decoding the signal received by the transceiving module 501, etc. The transceiving module 502 may be configured to support the communication apparatus 500 to perform communication, and the transceiving module 501 may have a wireless communication function, for example, may be capable of performing wireless communication with other communication apparatuses through a wireless air interface.

When performing the steps implemented by the network device 102, the processing module 501 is configured to determine time-frequency resource configuration information for the user equipment 101 based on the inter-frequency simultaneous transmission capability of the user equipment 101, where the inter-frequency simultaneous transmission capability is used for indicating the capability of the user equipment 101 to transmit the service data of the first communication interface and the service data of the second communication interface simultaneously on the same time-domain unit corresponding to different frequency points within the same licensed frequency band. The transceiving module 502 is configured to send the time-frequency resource configuration information to the user equipment 101.

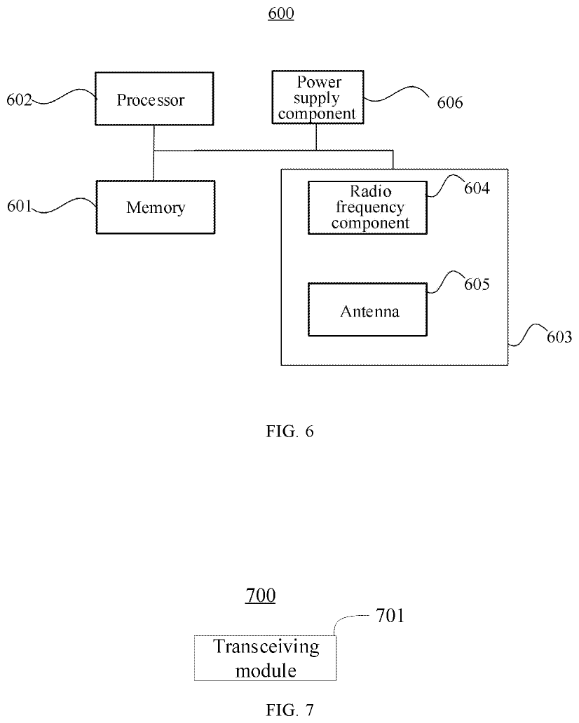

When the communication apparatus is a network device 102, the structure of the communication apparatus may also be as shown in FIG. 6. A base station is used as an example to illustrate the structure of the communication apparatus. As shown in FIG. 6, the communication apparatus 600 includes a memory 601, a processor 602, a transceiving component 603, and a power supply component 606. Among them, the memory 601 is coupled to the processor 602, and may be configured to store programs and data necessary for the communication apparatus 600 to implement the various functions. The processor 602 is configured to support the communication apparatus 600 to perform corresponding functions in the foregoing method, and the functions may be implemented by invoking the programs stored in the memory 601. The transceiving component 603 may be a wireless transceiver, and may be configured to support the communication apparatus 600 to receive signaling and/or data, and send signaling and/or data via a wireless air interface. The transceiving component 603 may also be referred to as a transceiver unit or a communication unit. The transceiving component 603 may include a radio frequency component 604 and one or more antennas 605. Among them, the radio frequency component 604 may be a remote radio unit (RRU), and may be specifically configured for transmission of radio frequency signals and conversion between radio frequency signals and baseband signals. The one or more antennas 605 may be specifically configured to transmit and receive radio frequency signals.

When the communication apparatus 600 needs to send data, the processor 602 may perform baseband processing on the data to be sent and then output the baseband signal to the radio frequency unit; the radio frequency unit performs radio frequency processing on the baseband signal and then sends the radio frequency signal in the form of electromagnetic waves through the antenna. When the data is sent to the communication apparatus 600, the radio frequency unit receives the radio frequency signal through the antenna, converts the radio frequency signal into a baseband signal, and outputs the baseband signal to the processor 602; and the processor 602 converts the baseband signal into data and performs processing on the data.

Based on the same concept as that in the foregoing method embodiments, according to embodiments of the present disclosure, there is further provided a communication apparatus. The communication apparatus may have the functions of the user equipment 101 in the foregoing method embodiments, and may be configured to perform the steps performed by the user equipment 101 provided by the foregoing method embodiments. The functions may be implemented by hardware, or may be implemented by software or by hardware that executes corresponding software. The hardware or software includes one or more modules corresponding to the foregoing functions.

In a possible implementation, the communication apparatus 700 as shown in FIG. 7 may be used as the user equipment 101 involved in the foregoing method embodiments, and may perform the steps performed by the user equipment 101 in the foregoing method embodiments. As shown in FIG. 7, the communication apparatus 700 may include a transceiving module 701. The transceiving module 701 may be configured to support the communication apparatus 700 to perform communication, and the transceiving module 701 may have a wireless communication function, for example, may be capable of performing wireless communication with another communication apparatus through a wireless air interface.

When performing the steps implemented by the user equipment 101, the transceiving module 701 is configured to receive the time-frequency resource configuration information from the network device 102; where the time-frequency resource configuration information is determined by the network device 102 based on the inter-frequency simultaneous transmission capability of the user equipment 101, and the inter-frequency simultaneous transmission capability is used for indicating the capability of the user equipment 101 to transmitting the service data of the first communication interface and the service data of the second communication interface simultaneously on the same time domain unit corresponding to different frequency points within the same licensed frequency band.

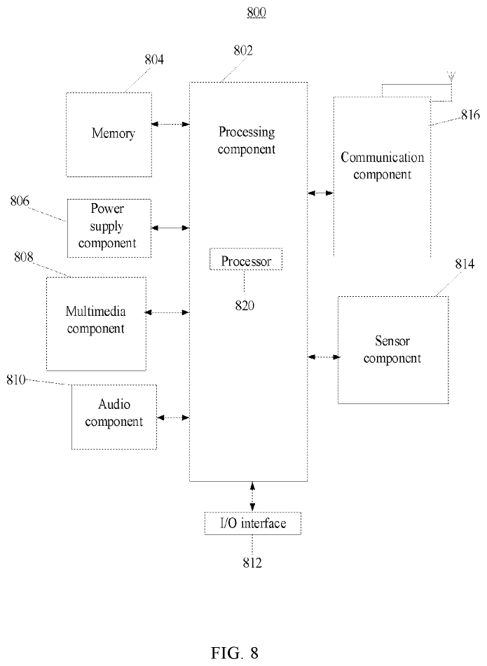

When the communication apparatus is the user equipment 101, the structure of the communication apparatus may also be as shown in FIG. 8. The communication apparatus 800 may be a mobile phone, a computer, a digital broadcast terminal, a message transceiving device, a game console, a tablet device, a medical device, a fitness device, a personal digital assistant, etc.

Referring to FIG. 8, the apparatus 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operation of the apparatus 800, such as operations associated with display, telephone calls, data communications, camera operations, and recording operations. The processing component 802 may include one or more processors 820 to execute instructions to complete all or part of the steps of the foregoing methods. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the apparatus 800. Examples of such data include instructions for any application or method operating on apparatus 800, contact data, phonebook data, messages, pictures, videos, or the like. The memory 804 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power supply component 806 provides electrical power to various components of apparatus 800. The power supply component 806 may include a power management system, one or more power sources, and other components associated with generating, managing, and distributing power for apparatus 800.

The multimedia component 808 includes a screen providing an output interface between the apparatus 800 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding, and gestures on the touch panel. The touch sensor may not only sense a boundary of the touching or sliding action, but also detect a duration and pressure associated with the touching or sliding action. In some embodiments, the multimedia component 808 includes a front-facing camera and/or a rear-facing camera. When the apparatus 800 is in an operation mode, such as a photographing mode or a video mode, the front-facing camera and/or the rear-facing camera may receive external multimedia data. Each of the front-facing camera and/or the rear-facing camera may be a fixed optical lens system, or may have a focal length and an optical zoom capability.

The audio component 810 is configured to output and/or input an audio signal. For example, the audio component 810 includes a microphone (MIC) configured to receive an external audio signal when the apparatus 800 is in an operating mode, such as a call mode, a recording mode, and a speech recognition mode. The received audio signal may be further stored in the memory 804 or transmitted via the communication component 816. In some embodiments, the audio component 810 further includes a speaker configured to output an audio signal.

The I/O interface 812 provides an interface between the processing component 802 and a peripheral interface module, and the peripheral interface module may be a keyboard, a click wheel, a button, or the like. The button may include, but is not limited to, a home button, a volume button, a start button, and a lock button.

The sensor component 814 includes one or more sensors for providing status assessments of various aspects of the apparatus 800. For example, the sensor component 814 may detect the open/closed state of the apparatus 800, and the relative positioning of the components; for example, these components may be the display and the keypad of the apparatus 800. The sensor component 814 may also detect the position change of the apparatus 800 or a component of the apparatus 800, the presence or absence of contact between the user and the apparatus 800, the orientation or acceleration/deceleration of the apparatus 800, and the temperature change of the apparatus 800. The sensor component 814 may include a proximity sensor configured to detect the presence of nearby objects without any physical contact. The sensor component 814 may also include an optical sensor, such as a CMOS or CCD image sensor, for use in an imaging application. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the apparatus 800 and other devices. The apparatus 800 may access a wireless network based on a communication standard, such as WiFi, 4G or 5G, or a combination of them. In some embodiments, the communication component 816 receives broadcast signals or broadcast related information from an external broadcast management system via a broadcast channel. In some embodiments, the communication component 816 further includes a near field communication (NFC) module to facilitate short-range communication. For example, the NFC module may be implemented based on a radio frequency identification (RFID) technology, an infrared data association (IrDA), an ultra-wideband (UWB) technology, a Bluetooth (BT) technology, and other technologies.

In some embodiments, the apparatus 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for performing the foregoing methods.

In some embodiments, there is further provided a non-transitory computer-readable storage medium including an instruction, for example, a memory 804 including an instruction. The instruction may be executed by the processor 820 of the apparatus 800 to complete the foregoing method. For example, the non-transitory computer-readable storage medium may be a ROM, a random access memory (RAM), a CD-ROM, a magnetic tape, a floppy disk, an optical data storage device, etc.

According to embodiments of the present disclosure, there is provided a method and apparatus for transmitting time-frequency resource configuration information, and a readable storage medium.

In a first aspect, according to embodiments of the present disclosure, there is provided a method for transmitting time-frequency resource configuration information. The method is performed by a network device, and the method includes:
determining time-frequency resource configuration information for user equipment based on an inter-frequency simultaneous transmission capability of the user equipment; where the inter-frequency simultaneous transmission capability is used for indicating a capability of the user equipment to transmit service data of a first communication interface and service data of a second communication interface simultaneously on a same time domain unit corresponding to different frequency points within a same licensed frequency band; and
sending the time-frequency resource configuration information to the user equipment.

By using the method, the network device can configure different time-frequency resource configuration information for the user equipment with different inter-frequency simultaneous transmission capabilities according to the inter-frequency simultaneous transmission capability of the user equipment, so as to configure reasonable time-frequency resource configuration information for various user equipment with different inter-frequency simultaneous transmission capabilities, and reasonably schedule the user equipment with different capabilities, thus avoiding the problem of network resource waste caused by weak scheduling performed on the user equipment with relatively strong inter-frequency simultaneous transmission capability, and avoiding the problem of abnormal data transmission caused by strong scheduling performed on the user equipment with relatively weak inter-frequency simultaneous transmission capability.

In some embodiments, a time domain resource corresponding to the first communication interface includes an uplink time domain unit and a downlink time domain unit;
a time domain resource corresponding to the second communication interface only includes an uplink time domain unit; and
the same time domain unit is a same uplink time domain unit in the time domain resource corresponding to the first communication interface.

In some embodiments, the first communication interface is a cellular communication interface; and the second communication interface is a sidelink communication interface.

In some embodiments, the inter-frequency simultaneous transmission capability of the user equipment includes following capabilities of:
sending the service data of the first communication interface and sending the service data of the second communication interface simultaneously on the same time domain unit corresponding to different frequency points within the same licensed frequency band; and
sending the service data of the first communication interface and receiving the service data of the second communication interface simultaneously on the same time domain unit corresponding to different frequency points within the same licensed frequency band;
the time-frequency resource configuration information for the user equipment includes one of following:
an uplink time domain resource corresponding to the first communication interface including an uplink time domain resource of the second communication interface and a downlink time domain resource of the second communication interface;
an uplink time domain resource corresponding to the first communication interface including an uplink time domain resource of the second communication interface; and
an uplink time domain resource corresponding to the first communication interface including a downlink time domain resource of the second communication interface.

In this method, the network device configures a relatively flexible time-frequency resource configuration for the user equipment with a relatively strong inter-frequency simultaneous transmission capability, so as to make full use of the inter-frequency simultaneous transmission capability of the user equipment

In some embodiments, the inter-frequency simultaneous transmission capability of the user equipment includes following capability of:
sending the service data of the first communication interface and sending the service data of the second communication interface simultaneously on the same time domain unit corresponding to different frequency points within the same licensed frequency band;
the time-frequency resource configuration information for the user equipment includes:
an uplink time-domain resource corresponding to the first communication interface including an uplink time-domain resource of the second communication interface, and not including a downlink time-domain resource of the second communication interface.

In this method, the network device only configures the uplink time domain resource of the second communication interface in the uplink time domain resource corresponding to the first communication interface for the user equipment with moderate inter-frequency simultaneous transmission capability, so as to make full use of the inter-frequency simultaneous sending capability of the user equipment

In some embodiments, the inter-frequency simultaneous transmission capability of the user equipment does not include any one of following capabilities of:
sending the service data of the first communication interface and sending the service data of the second communication interface simultaneously on the same time domain unit corresponding to different frequency points within the same licensed frequency band; and
sending the service data of the first communication interface and receiving the service data of the second communication interface simultaneously on the same time domain unit corresponding to different frequency points in the same licensed frequency band;
the time-frequency resource configuration information for the user equipment includes:
an uplink time domain resource corresponding to the first communication interface not including an uplink time domain resource of the second communication interface, and not including a downlink time domain resource of the second communication interface.

In this method, the network device configures the time-frequency resource configuration information for the user equipment with the worst inter-frequency simultaneous transmission capability, so as to prevent a data transmission conflict between the first communication interface and the second communication interface

In some embodiments, the method further includes:
sending a reporting command to the user equipment, where the reporting command is used for instructing the user equipment to report the inter-frequency simultaneous transmission capability of the user equipment.

In some embodiments, the method further includes:
receiving a reporting result of the user equipment, where the reporting result is used for indicating the inter-frequency simultaneous transmission capability of the user equipment.

In a second aspect, according to embodiments of the present disclosure, there is provided a method for transmitting time-frequency resource configuration information. The method is performed by a user equipment, and the method includes:
receiving time-frequency resource configuration information from a network device;
where the time-frequency resource configuration information is determined by the network device based on an inter-frequency simultaneous transmission capability of the user equipment; and the inter-frequency simultaneous transmission capability is used for indicating a capability of the user equipment to transmit service data of a first communication interface and service data of a second communication interface simultaneously on a same time domain unit corresponding to different frequency points within a same licensed frequency band.

By using the method, the network device can configure different time-frequency resource configuration information for the user equipment with different inter-frequency simultaneous transmission capabilities according to the inter-frequency simultaneous transmission capability of the user equipment, so as to configure reasonable time-frequency resource configuration information for various user equipment with different inter-frequency simultaneous transmission capabilities, and reasonably schedule the user equipment with different capabilities, thus avoiding the problem of network resource waste caused by weak scheduling performed on the user equipment with relatively strong inter-frequency simultaneous transmission capability, and avoiding the problem of abnormal data transmission caused by strong scheduling performed on the user equipment with relatively weak inter-frequency simultaneous transmission capability. The user equipment may receive the time-frequency resource configuration information configured by the network device and corresponding to its own inter-frequency simultaneous transmission capability. Therefore, the user equipment can perform service processing according to the time-frequency resource configuration information, so that its own capability can be exerted to the maximum extent and the service can be processed reasonably and efficiently.

In some embodiments, a time domain resource corresponding to the first communication interface includes an uplink time domain unit and a downlink time domain unit;
a time domain resource corresponding to the second communication interface only includes an uplink time domain unit; and
the same time domain unit is a same uplink time domain unit in the time domain resource corresponding to the first communication interface

In some embodiments, the first communication interface is a cellular communication interface; and
the second communication interface is a sidelink communication interface.

In some embodiments, he method further includes:
receiving a reporting command from the network device; where the reporting command is used for instructing the user equipment to report the inter-frequency simultaneous transmission capability of the user equipment.

In some embodiments, he method further includes:
sending a reporting result of the user equipment to the network device; where the reporting result is used for indicating the inter-frequency simultaneous transmission capability of the user equipment.

In some embodiments, the inter-frequency simultaneous transmission capability of the user equipment includes following capabilities of:
sending the service data of the first communication interface and sending the service data of the second communication interface simultaneously on the same time domain unit corresponding to different frequency points within the same licensed frequency band; and
sending the service data of the first communication interface and receiving the service data of the second communication interface simultaneously on the same time domain unit corresponding to different frequency points within the same licensed frequency band;
the time-frequency resource configuration information for the user equipment includes one of following:
an uplink time domain resource corresponding to the first communication interface including an uplink time domain resource of the second communication interface and a downlink time domain resource of the second communication interface;
an uplink time domain resource corresponding to the first communication interface including an uplink time domain resource of the second communication interface; and
an uplink time domain resource corresponding to the first communication interface including a downlink time domain resource of the second communication interface

In some embodiments, the inter-frequency simultaneous transmission capability of the user equipment includes following capability of:
sending the service data of the first communication interface and sending the service data of the second communication interface simultaneously on the same time domain unit corresponding to different frequency points within the same licensed frequency band;
the time-frequency resource configuration information for the user equipment includes:
an uplink time-domain resource corresponding to the first communication interface including an uplink time-domain resource of the second communication interface, and not including a downlink time-domain resource of the second communication interface

In some embodiments, the inter-frequency simultaneous transmission capability of the user equipment does not include any one of following capabilities of:
sending the service data of the first communication interface and sending the service data of the second communication interface simultaneously on the same time domain unit corresponding to different frequency points within the same licensed frequency band; and
sending the service data of the first communication interface and receiving the service data of the second communication interface simultaneously on the same time domain unit corresponding to different frequency points in the same licensed frequency band;
the time-frequency resource configuration information for the user equipment includes:
an uplink time domain resource corresponding to the first communication interface not including an uplink time domain resource of the second communication interface, and not including a downlink time domain resource of the second communication interface.

In a third aspect, according to embodiments of the present disclosure, there is provided a communication apparatus. The communication apparatus may be configured to perform the steps performed by the network device in the first aspect or any possible design of the first aspect. The network device may implement the various functions of the foregoing methods in the form of a hardware structure, a software module, or a hardware structure plus a software module.

When the communication apparatus shown in the third aspect is implemented by the software module, the communication apparatus may include a processing module and a transceiving module coupled to each other; where the processing module may be configured for the communication apparatus to perform a processing operation, for example, to generate the information/message that needs to be sent, or to process the received signal to obtain the information/message; and, the transceiving module may be configured to support the communication apparatus to perform communication.

When performing steps in the first aspect, the processing module is configured to determine time-frequency resource configuration information for the user equipment based on the inter-frequency simultaneous transmission capability of the user equipment; where the inter-frequency simultaneous transmission capability is used for indicating the capability of the user equipment to transmit the service data of the first communication interface and the service data of the second communication interface simultaneously on the same time-domain unit corresponding to different frequency points within the same licensed frequency band; and, the transceiving module is configured to send the time-frequency resource configuration information to the user equipment.

In a fourth aspect, according to embodiments of the present disclosure, there is provided a communication apparatus. The communication apparatus may be configured to perform steps performed by the user equipment in the second aspect or any possible design of the second aspect. The user equipment may implement the various functions of the foregoing methods in the form of a hardware structure, a software module, or a hardware structure plus a software module.

When the communication apparatus shown in the fourth aspect is implemented by the software module, the communication apparatus may include a transceiving module, where the transceiving module may be configured to support the communication apparatus to perform communication.

When performing steps in the second aspect, the transceiving module is configured to receive the time-frequency resource configuration information from the network device; where the time-frequency resource configuration information is determined by the network device based on the inter-frequency simultaneous transmission capability of the user equipment, and the inter-frequency simultaneous transmission capability is used for indicating the capability of the user equipment to transmit the service data of the first communication interface and the service data of the second communication interface simultaneously on the same time domain unit corresponding to different frequency points of the user equipment within the same licensed frequency band.

In a fifth aspect, according to the present disclosure, there is provided a communication apparatus, including a processor and a memory, where the memory is configured to store a computer program; and the processor is configured to execute the computer program to implement the first aspect or any one possible design of the first aspect.

In a sixth aspect, according to the present disclosure, there is provided a communication apparatus, including a processor and a memory, where the memory is configured to store a computer program; and the processor is configured to execute the computer program to implement the second aspect or any one possible design of the second aspect.

In a seventh aspect, according to the present disclosure, there is provided a non-transitory computer-readable storage medium, where an instruction (or a computer program or a program) is stored in the computer-readable storage medium, and when the instruction is invoked and executed on a computer, the computer is enabled to perform the first aspect or any one possible design of the first aspect.

In an eighth aspect, according to the present disclosure, there is provided a non-transitory computer-readable storage medium, where an instruction (or a computer program or a program) is stored in the computer-readable storage medium, and when the instruction is invoked and executed on a computer, the computer is enabled to perform the second aspect or any one possible design of the second aspect.

The beneficial effects in the second aspect to the eighth aspect and the possible designs of them may refer to the description of the beneficial effects of the methods in the first aspect and any possible design of the first aspect.

Other embodiments of the embodiments of the present disclosure will be apparent to those skilled in the art from consideration of the specification and practice of the disclosure disclosed here. The present disclosure is intended to cover any variations, uses, or adaptations of the embodiments of the present disclosure following the general principles of the embodiments of the present disclosure and including common general knowledge or conventional technical means in the art not disclosed in the present disclosure. The description and embodiments are considered as examples only, with the true scope and spirit of the embodiments of the present disclosure being indicated by the following claims.

It should be understood that the embodiments of the present disclosure are not limited to the precise structures that have been described above and shown in the accompanying drawings, and various modifications and changes may be made without departing from the scope of the embodiments of the present disclosure. The scope of the embodiments of the present disclosure is limited only by the appended claims.

### Industrial Applicability

The network device can configure different time-frequency resource configuration information for the user equipment with different inter-frequency simultaneous transmission capabilities according to the inter-frequency simultaneous transmission capability of the user equipment, so as to configure reasonable time-frequency resource configuration information for various user equipment with different inter-frequency simultaneous transmission capabilities, and reasonably schedule the user equipment with different capabilities, thus avoiding the problem of network resource waste caused by weak scheduling performed on the user equipment with relatively strong inter-frequency simultaneous transmission capability, and avoiding the problem of abnormal data transmission caused by strong scheduling performed on the user equipment with relatively weak inter-frequency simultaneous transmission capability.

1. A method for transmitting time-frequency resource configuration information, performed by a network device, and comprising:
determining time-frequency resource configuration information for user equipment based on inter-frequency simultaneous transmission capability of the user equipment; wherein the inter-frequency simultaneous transmission capability is configured for indicating capability of the user equipment to transmit service data of a first communication interface and service data of a second communication interface simultaneously on a same time domain unit corresponding to different frequency points within a same licensed frequency band; and
sending the time-frequency resource configuration information to the user equipment.

2. The method according to claim 1, wherein, a time domain resource corresponding to the first communication interface comprises an uplink time domain unit and a downlink time domain unit;
a time domain resource corresponding to the second communication interface only comprises an uplink time domain unit; and
the same time domain unit is a same uplink time domain unit in the time domain resource corresponding to the first communication interface.

3. The method according to claim 2, wherein, the first communication interface is a cellular communication interface; and
the second communication interface is a sidelink communication interface.

4. The method according to claim 1, wherein,
the inter-frequency simultaneous transmission capability of the user equipment comprises:
capability of sending the service data of the first communication interface and sending the service data of the second communication interface simultaneously on the same time domain unit corresponding to different frequency points within the same licensed frequency band; and
the time-frequency resource configuration information for the user equipment comprises:
an uplink time-domain resource corresponding to the first communication interface comprising an uplink time-domain resource of the second communication interface, and excluding a downlink time-domain resource of the second communication interface.

5. The method according to claim 1, wherein,
the inter-frequency simultaneous transmission capability of the user equipment comprises:
capability of sending the service data of the first communication interface and sending the service data of the second communication interface simultaneously on the same time domain unit corresponding to different frequency points within the same licensed frequency band; and
capability of sending the service data of the first communication interface and receiving the service data of the second communication interface simultaneously on the same time domain unit corresponding to different frequency points within the same licensed frequency band; and
the time-frequency resource configuration information for the user equipment comprises at least one of following:
an uplink time domain resource corresponding to the first communication interface comprising an uplink time domain resource of the second communication interface and a downlink time domain resource of the second communication interface;
an uplink time domain resource corresponding to the first communication interface comprising an uplink time domain resource of the second communication interface; and
an uplink time domain resource corresponding to the first communication interface comprising a downlink time domain resource of the second communication interface.

6. The method according to claim 1, wherein,
the inter-frequency simultaneous transmission capability of the user equipment excludes any one of following:
capability of sending the service data of the first communication interface and sending the service data of the second communication interface simultaneously on the same time domain unit corresponding to different frequency points within the same licensed frequency band; and
capability of sending the service data of the first communication interface and receiving the service data of the second communication interface simultaneously on the same time domain unit corresponding to different frequency points in the same licensed frequency band; and
the time-frequency resource configuration information for the user equipment comprises:
an uplink time domain resource corresponding to the first communication interface excluding an uplink time domain resource of the second communication interface, and excluding a downlink time domain resource of the second communication interface.

7. The method according to claim 1, wherein the method further comprises:
sending a reporting command to the user equipment, wherein the reporting command is configured for instructing the user equipment to report the inter-frequency simultaneous transmission capability of the user equipment.

8. The method according to claim 1, wherein the method further comprises:
receiving a reporting result of the user equipment, wherein the reporting result is configured for indicating the inter-frequency simultaneous transmission capability of the user equipment.

9. A method for transmitting time-frequency resource configuration information, performed by user equipment, and comprising:
receiving time-frequency resource configuration information from a network device;
wherein the time-frequency resource configuration information is determined by the network device based on inter-frequency simultaneous transmission capability of the user equipment; and the inter-frequency simultaneous transmission capability is configured for indicating capability of the user equipment to transmit service data of a first communication interface and service data of a second communication interface simultaneously on a same time domain unit corresponding to different frequency points within a same licensed frequency band.

10. The method according to claim 9, wherein, a time domain resource corresponding to the first communication interface comprises an uplink time domain unit and a downlink time domain unit;
a time domain resource corresponding to the second communication interface only comprises an uplink time domain unit; and
the same time domain unit is a same uplink time domain unit in the time domain resource corresponding to the first communication interface.

11. The method according to claim 10, wherein, the first communication interface is a cellular communication interface; and
the second communication interface is a sidelink communication interface.

12. The method according to claim 9, wherein the method further comprises:
receiving a reporting command from the network device; wherein the reporting command is configured for instructing the user equipment to report the inter-frequency simultaneous transmission capability of the user equipment.

13. The method according to claim 9, wherein the method further comprises:
sending a reporting result of the user equipment to the network device; wherein the reporting result is configured for indicating the inter-frequency simultaneous transmission capability of the user equipment.

14. The method according to claim 9, wherein, the inter-frequency simultaneous transmission capability of the user equipment comprises:
capability of sending the service data of the first communication interface and sending the service data of the second communication interface simultaneously on the same time domain unit corresponding to different frequency points within the same licensed frequency band; and
the time-frequency resource configuration information for the user equipment comprises:
an uplink time-domain resource corresponding to the first communication interface comprising an uplink time-domain resource of the second communication interface, and excluding a downlink time-domain resource of the second communication interface.

15. The method according to claim 9, wherein, the inter-frequency simultaneous transmission capability of the user equipment comprises:
capability of sending the service data of the first communication interface and sending the service data of the second communication interface simultaneously on the same time domain unit corresponding to different frequency points within the same licensed frequency band; and
capability of sending the service data of the first communication interface and receiving the service data of the second communication interface simultaneously on the same time domain unit corresponding to different frequency points within the same licensed frequency band; and
the time-frequency resource configuration information for the user equipment comprises at least one of following:
an uplink time domain resource corresponding to the first communication interface comprising an uplink time domain resource of the second communication interface and a downlink time domain resource of the second communication interface;
an uplink time domain resource corresponding to the first communication interface comprising an uplink time domain resource of the second communication interface; and
an uplink time domain resource corresponding to the first communication interface comprising a downlink time domain resource of the second communication interface.

16. The method according to claim 9, wherein, the inter-frequency simultaneous transmission capability of the user equipment excludes any one of following:
capability of sending the service data of the first communication interface and sending the service data of the second communication interface simultaneously on the same time domain unit corresponding to different frequency points within the same licensed frequency band; and
capability of sending the service data of the first communication interface and receiving the service data of the second communication interface simultaneously on the same time domain unit corresponding to different frequency points in the same licensed frequency band; and
the time-frequency resource configuration information for the user equipment comprises:
an uplink time domain resource corresponding to the first communication interface excluding an uplink time domain resource of the second communication interface, and excluding a downlink time domain resource of the second communication interface.

17-18. (canceled)

19. A communication apparatus, comprising a processor and a memory;
wherein the memory is configured to store a computer program; and
the processor is configured to execute the computer program to implement a method for transmitting time-frequency resource configuration information, comprising:
determining time-frequency resource configuration information for user equipment based on inter-frequency simultaneous transmission capability of the user equipment; wherein the inter-frequency simultaneous transmission capability is configured for indicating capability of the user equipment to transmit service data of a first communication interface and service data of a second communication interface simultaneously on a same time domain unit corresponding to different frequency points within a same licensed frequency band; and
sending the time-frequency resource configuration information to the user equipment.

20. A communication apparatus, comprising: a processor and a memory;
wherein the memory is configured to store a computer program; and
the processor is configured to execute the computer program to implement the method according to claim 9.

21. A non-transitory computer-readable storage medium, wherein an instruction is stored in the non-transitory computer-readable storage medium, and when the instruction is invoked and executed on a computer, the computer is enabled to perform the method according to claim 1.

22. A non-transitory computer-readable storage medium, wherein an instruction is stored in the non-transitory computer-readable storage medium, and when the instruction is invoked and executed on a computer, the computer is enabled to perform the method according to claim 9.
